(19) United States
(12) Patent Application Publication
(10) Pub. No.: US 2010/0261832 A1
(43) Pub. Date: Oct. 14, 2010

(54) PROCESS FOR THE PREPARATION OF A FILM OR A COATING ON A SUBSTRATE WITH AN AQUEOUS DISPERSION OF POLYMER PARTICLES AND THE RESULTING FILMS AND COATINGS

(76) Inventors: Stephanie Magnet, Morianne (FR); Thomas Roussel, Lyon (FR)

Correspondence Address: ARKEMA INC.;PATENT DEPARTMENT - 26TH FLOOR, 2000 MARKET STREET, PHILADELPHIA, PA, 19103-3222, US

(21) Appl. No.: 12/746,015

(22) PCT Filed: Dec. 8, 2008
(86) PCT No.: PCT/EP2008/067035

§ 371 Date: Jun. 3, 2010

(30) Foreign Application Priority Data
Dec. 7, 2007 (FR) 0759649

(51) Int. Cl. C09D 153/00; C09J 153/00

(52) U.S. Cl. 524/505; 524/500

(57) ABSTRACT

“Process for the preparation of a film or coating on a solid substrate, comprising at least one step of applying to the substrate an aqueous dispersion of polymer particles, composed of a mixture, on the one hand, of one or more block copolymers and, on the other hand, of one or more random copolymers and/or homopolymers; or of a coating composition containing said aqueous dispersion. Said coating composition is, in particular, a paint, a composition for the coating of textiles, of leather or of non-woven fabrics; a composition for the coating of paper; an adhesive composition. Film or coating capable of being obtained by this process.”

### TECHNICAL FIELD

The invention relates to a process for the preparation of a film or coating on a substrate in which an aqueous dispersion of polymer particles or a coating composition comprising said dispersion is applied to this substrate. More specifically, this dispersion is prepared directly by a radical polymerization process in dispersion in several stages.

The invention also relates to a film or coating capable of being obtained by this process.

Finally, the invention relates to the use of said dispersion in paints; compositions or formulations for the coating of textiles, leather or nonwovens; adhesive compositions or formulations; or compositions for coating paper.

The technical field of the invention can be defined as that of aqueous dispersions of polymers or synthetic resins and more particularly as that of aqueous polymer emulsions.

Aqueous polymer dispersions and in particular emulsions can be defined as fluid systems which comprise polymer particles distributed in the form of a phase dispersed in an aqueous dispersing medium forming an aqueous continuous phase.

The size, generally defined by their diameter, of the polymer particles is generally from 0.01 to 5 micrometers, preferably from 0.02 to 1 micrometer.

Aqueous polymer dispersions or emulsions have the property of forming transparent polymer films during the evaporation of the aqueous dispersing medium and this is the reason why these dispersions and emulsions are widely used as binders, for example in coating compositions.

However, in contrast to polymer solutions, the type of dispersed polymer and the temperature at which the formation of a film takes place determine whether an aqueous polymer emulsion forms, after evaporation of the water, a coherent transparent film or else an opaque or brittle layer.

The lowest temperature at which a transparent film is formed without cracking is defined as being the Minimal Filmification Temperature (MFT) of said dispersion or emulsion.

A film is not formed below the MFT.

It is known to a person skilled in the art that the film-forming nature of an aqueous dispersion of polymer or synthetic resin and the properties of toughness and tack of the film or coating obtained from this dispersion can be adjusted by varying the nature of monomers constituting the aqueous dispersion and the ratios by weight of the various monomers.

Thus, it is known that aqueous polymer emulsions which essentially comprise polymerized monomers, the corresponding homopolymers of which have “low” glass transition temperatures (T_{g}), that is to say generally less than ambient temperature (namely, generally, 20 to 25° C., for example 22 or 23° C.), can form polymer films at low temperatures. In other words, these emulsions have an MFT in the vicinity of the T_{g} of the polymer.

However, a disadvantage of the films obtained from such emulsions is that they are too soft and too tacky for many applications.

In particular, the coatings or films obtained from these dispersions or emulsions generally have a low blocking temperature (BT).

The blocking temperature, which characterizes the tack of the film, is generally defined as the temperature from which two parts of the same film adhere to one another when they are brought into contact with one another at a predetermined contact pressure for a certain period of time.

Above the blocking temperature, the films adhere to one another and can no longer be separated without being damaged.

For example, acrylic monomers which have a glass transition temperature (T_{g}) lower than ambient temperature contribute properties of low-temperature filmability and the flexibility to the films obtained. However, these films exhibit a very pronounced adhesive or tacky nature as the amount of acrylic monomers in the composition increases.

It is also known that aqueous polymer emulsions which essentially comprise polymerized monomers, the corresponding homopolymers of which have “high” glass transition temperatures (T_{g}), that is to say generally of greater than 50° C., have high blocking temperatures, that is to say generally of greater than 50° C.

Thus, methacrylic monomers, such as methyl methacrylate, or styrene monomers, such as styrene, the glass transition temperature (T_{g}) of which is greater than 50° C., confer, on the film obtained from the aqueous dispersion, properties of toughness and of resistance to blocking.

The disadvantages of these dispersions or emulsions which have high blocking temperatures is that they also have high MFTs.

By adjusting the various compositions by weight of the “soft” monomers (the T_{g}<Ambient temperature of which is preferably less than or equal to 10° C.), such as acrylic monomers, and of the “hard” monomers (the T_{g} of which is greater than or equal to 50° C.), such as methacrylic or styrene monomers, which participate in the composition of the aqueous polymer or synthetic resin dispersion or emulsion, it is possible, however, to obtain films from these dispersions or emulsions, the properties of which can range from films exhibiting a strong adhesive (tacky) nature to rigid films.

It is very obvious that the aqueous polymer or synthetic resin dispersions have to exhibit a pronounced film-forming nature. For this, it is necessary to prepare aqueous dispersions having a low minimal filmification temperature (MFT) as defined above. However, in all the cases and for all the dispersions described above, the blocking temperature characterizing the tack of the film is in fact only slightly greater than the minimal filmification temperature (MFT), which is a great use in the majority of the applications of these dispersions.

The prior art describes three possible methods which make it possible to adjust the minimal filmification temperature and the blocking temperature of an aqueous dispersion for a targetted application:
the first method consists in adding plasticizing agents (or coalescence agents) to aqueous dispersions of hard polymers;
the second method provides for the copolymerization of the “soft” monomers (T_{g} less than or equal to 10° C.) and of the “hard” monomers (T_{g} greater than or equal to 50° C.);
finally, the third method consists in mixing aqueous dispersions of “hard” polymers with aqueous dispersions of “soft” polymers.
   However, the disadvantage of the first method is that it increases the content of volatile compounds in the aqueous dispersion due to the addition of the plasticizer (or coalescence agent).

Furthermore, the disadvantage of the second and third methods is that the minimal filmification temperature and the blocking temperature vary in the same direction and by the same order of magnitude. The consequence of this is that the difference in temperature between the minimal filmification temperature and the blocking temperature is not effectively increased; generally, a difference in temperature between the MFT and the BT of the order of 20° C. is obtained, which is entirely inadequate.

Multistage polymerization techniques were then developed in order to increase this temperature difference between the MFT and the BT.

Thus, patents EP 184 091, EP 376 096, EP 609 756, EP 379 892 and U.S. Pat. No. 5,744,540 describe processes for obtaining an aqueous dispersion of synthetic resins by a conventional aqueous emulsion radical polymerization process in two successive stages, one of the stages, for example the first stage, consisting in polymerizing a soft monomer or mixture of soft monomers which exhibits a low glass transition temperature and the other stage, for example the second stage, consisting of polymerizing a hard monomer or a mixture of hard monomers which exhibits a high glass transition temperature. The order in which these two polymerization sequences are carried out does not appear to play a predominant role in the application. Thus, patent EP 379 892 describes the preparation of an aqueous resin dispersion during which the hard polymer is constructed in the first stage and the soft polymer is constructed in the second stage, whereas patent EP 184 091 describes the opposite.

The aqueous dispersions of synthetic resins resulting from these successive conventional radical polymerization stages have specific morphologies which are more generally denoted by the expression “core/shell”. The core is composed of the monomers or the mixture of monomers polymerized during the first stage, whereas the shell is composed of the monomers or mixture of monomers polymerized during the second stage.

Thus, for example, the document U.S. Pat. No. 5,306,743 relates to aqueous dispersions of synthetic resins comprising latex particles having a mean particle diameter of less than 140 nm, these particles being composed of 5 to 45% by weight of a core material having a T_{g} of greater than 60° C., and of 95 to 55% by weight of a shell material having a temperature T_{g} of less than 80° C. and lower by at least 20 K than the temperature of the nucleus.

The dispersions prepared have MFTs of 0, 12, 21 and 25° C. and BTs of 35, 40, 45, 50 and 55° C.; the temperature difference between the BT and the MFT ranges from 25° C. to 43° C.

The films obtained from the aqueous dispersions of synthetic resins which are polymerized by a conventional multistage radical polymerization process and which have said core/shell structure thus exhibit a temperature difference between the minimal filmification temperature and the blocking temperature of the order of 40° C., which remains inadequate.

The document U.S. Pat. No. B1-6,710,112 describes an aqueous polymer dispersion having a minimal filmification temperature of less than 65° C. and of more than −35° C., preferably within the range from −20° C. to 40° C. and in particular within the range from 0 to 40° C., which comprises at least one film-forming polymer in the form of dispersed particles comprising a polymer phase P1 having a T_{g}1 and a different polymer phase P2 having a T_{g}2. This aqueous polymer dispersion is capable of being obtained by a conventional aqueous emulsion radical polymerization process comprising a stage of polymerization of a first charge of monomers M1, to give the polymer P1, and a stage of polymerization of a second charge of monomers M2, to give the polymer P2.

The charge M2 is chosen in order to give a “hard” polymer with a T_{g}2 of greater than 30° C., preferably of more than 40° C. and in particular within the range from 50 to 120° C., and at least one chain transfer agent is used, either in the polymerization of the charge M1 or in the polymerization of the charge M2. The dispersions prepared in the examples of this document have MFTs of 24 to 29° C., which cannot be regarded as being low.

The document WO-A-2007/017614 describes a process for the preparation of a polymer material comprising a multiblock polymer which comprises at least one cycle of stages comprising:

a) a stage of synthesis of a block by a controlled radical polymerization of one or more monomers which can be polymerized by the radical route; and

b) a stage of polymerization of the monomers not converted during stage a).

Stage a) is preferably carried out by SFRP in the presence of a monofunctional or polyfunctional alkoxyamine, which acts both as initiating agent and as control agent.

Stages b) are carried out by conventional radical polymerization by adding a conventional radical polymerization initiator to the medium in which the block was produced during stage a). The temperature of this stage is chosen so as to be lower than that of stage a) in order to retain the block previously synthesized in the form of a living polymer.

The process of this document is particularly suited to the preparation of a polymer material comprising an A-B diblock copolymer, such as a poly(n-butyl acrylate)-b-poly(methyl methacrylate) diblock copolymer.

In example 5 of this document, a latex is thus prepared simultaneously comprising a copolymer of n-butyl acrylate and of methyl methacrylate obtained by controlled radical polymerization; an n-butyl acrylate homopolymer and a methyl methacrylate homopolymer which are obtained by conventional radical polymerization.

However, this document is aimed essentially at the preparation of a dry solid polymer material and not of a dispersion. The polymers are, in this document, recovered in a dry solid form and not in the form of a dispersion.

It is mentioned that the dry solid polymer material prepared in this document can have an application as additive in the field of coatings.

There is thus no question in this document of the preparation of a coating with an aqueous dispersion but only of the use of dry solid polymer materials as additives for coatings, which clearly means that these coatings are based on other materials or other polymers.

The document FR-A-2 866 026 describes a miniemulsion, microemulsion or emulsion radical polymerization process employing alkoxyamines.

Controlled macromolecular architecture (co)polymer latexes are obtained by the process of this document.

The polymers obtained by the process of this document are living polymers carrying alkoxyamine functional groups and the process of this document makes possible the preparation of block polymers.

For this, a first polymer is polymerized by the process of this document, in order to obtain a living polymer block, and a block of another polymer is connected to this first block by placing the first living polymer block in a medium for the polymerization of a second monomer, and so on.

The residual monomers resulting from the controlled radical polymerization can be converted using a conventional free radical initiator.

The optional applications of the latexes prepared in this document, in particular in coatings, are neither touched on nor mentioned.

There thus exists a need for a process of the preparation of films or coatings starting from aqueous dispersions of synthetic resins which makes possible the preparation of films or coatings exhibiting a low MFT, for example of less than or equal to 10° C., thus making possible the preparation of these films or coatings at low temperature, for example less than or equal to 10° C.; these films or coatings additionally exhibiting a blocking temperature BT which is greater by at least 50° C. than the MFT.

In other words, there exists a need for a process for the preparation of films or coatings starting from synthetic resins or polymers which are flexible at low temperature and which also have, in addition, good mechanical and toughness properties.

The aim of the present invention is to provide a process for the preparation of films or coatings and also films or coatings which meet, inter alia, these needs.

The aim of the present invention is also to provide films or coatings prepared from aqueous polymer dispersions and a process for the preparation of these films or coatings which do not exhibit the disadvantages, failings and drawbacks of the films and coatings and of the processes for preparing these films and coatings of the prior art and which solve the problems of the coatings and processes for the preparation of these coatings of the prior art.

According to the invention, the use of certain aqueous dispersions of polymer particles makes it possible to achieve this aim.

The invention thus relates to a process for the preparation of a film or coating on a solid substrate, comprising at least one stage of application, to the substrate, of an aqueous dispersion of polymer particles composed of a blend, on the one hand, of one or more block copolymers and, on the other hand, of one or more homopolymers and/or random copolymers; or of a coating composition comprising said aqueous dispersion.

Each particle of the dispersion in fact comprises a blend of one or more block copolymers and of one or more homopolymers and/or copolymers, generally random copolymers.

The block copolymer or copolymers generally represent from 10 to 90%, preferably from 40 to 80%, of the total of the polymers of the dispersion employed and the homopolymer or homopolymers and/or random copolymer or copolymers generally represent from 0.1 to 60% of the total of the polymers of the dispersion used.

The aqueous dispersion is generally defined by a soft polymer(s)/hard polymer(s) ratio by weight generally lying in the range from 0.3 to 3, preferably from 0.5 to 1.5.

In order to calculate this ratio, “polymer” is understood to mean any polymer segment, whether in the form of an isolated, separate and independent random copolymer or of an isolated, separate and independent homopolymer or else whether it constitutes a block of a block copolymer (for example polymer constituting the block A, the block B or the block A′).

“Hard” polymer is understood to mean generally a polymer having a glass transition temperature (T_{g}) of greater than or equal to 50° C. and “soft” polymer is understood to mean generally a polymer having a glass transition temperature (T_{g}) of less than or equal to 10° C.

As will be seen later, the dispersions employed in the process according to the invention are prepared directly by a radical polymerization process in a specific dispersion, with which process it is possible, surprisingly, to directly obtain such dispersions in which the soft polymer(s)/hard polymer(s) ratio lies within the specific range mentioned above.

The dispersions employed in the process according to the invention, in particular those which exhibit such a soft polymer(s)/hard polymer(s) ratio, are particularly suitable for preparing films or coatings having a low MFT, namely an MFT of less than or equal to 10° C., preferably of less than or equal to 5° C., more preferably of less than or equal to 0° C., and simultaneously having a blocking temperature (BT) which is by at least 50° C. greater than the MFT temperature.

The dispersions employed in the prior art which are obtained by simple blending of dispersions, which are used to prepare coatings or films, do not make it possible to obtain a difference between the BT and the MFT of at least 50° C., whereas the dispersions employed according to the invention, preferably obtained directly by the polymerization process described below, make it possible to obtain a difference between the BT and the MFT of at least 50° C.,

The blend of polymers of the dispersion employed according to the invention can comprise, for example, a triblock copolymer A-B-A′ or diblock copolymer A-B, a homopolymer or random copolymer C and optionally a homopolymer or random copolymer D.

The blocks A, B and A′ are homopolymers or copolymers, in particular random copolymers.

C may or may not be composed of the same monomer or monomers as B, and D may or may not be composed of the same monomer or monomers as A or A′.

The block copolymer A-B-A′ or A-B generally represents between 10 and 90% of the total of the polymers of the dispersion, C generally represents between 0.1 and 40% of the total of the polymers of the dispersion and D, if it is present, generally represents between 0.1 and 40% of the total of the polymers of the dispersion.

The block copolymer A-B-A′ or A-B is obtained by the controlled radical polymerization stages of the process described later. The block B can be a homopolymer or a copolymer.

Preferably, the blocks A, A′ and D are hard and the blocks B and C are soft.

The polymers C and D are generally obtained by conventional free radical polymerization, generally in the context of one of the stages of the process for the preparation of the dispersion described below.

The particles of the dispersions employed in the process according to the invention generally have a particle size of less than 1000 nm, preferably from 20 to 500 nm.

The molecular weight of the polymers constituting the dispersion is generally from 20 000 to 1 000 000 g/mol, preferably from 20 000 to 500 000 g/mol.

In the process according to the invention, a dispersion as defined above or a coating composition comprising the aqueous dispersion as described in that which precedes can be applied to the substrate.

Such a coating composition generally comprises the dispersion described above and pigments and/or solvents and/or fillers, and the like.

The use of the dispersion described above, preferably prepared directly by the process described below, in coating compositions has never been described or suggested in the prior art.

This composition can be a paint; a composition for coating textiles, leather or nonwovens; a composition for coating paper; or an adhesive composition.

The process according to the invention for the preparation of a film or coating on a substrate comprises at least one stage of application, to the solid substrate, of an aqueous dispersion as defined above or of a coating composition comprising said aqueous dispersion.

The dispersion or coating composition can be applied to the substrate by any process known to a person skilled in the art in this field of the art.

There is no limitation with regard to the shape or size of the solid substrate and with regard to the nature of the material or materials of which it is composed.

The process according to the invention can comprise only a single stage of application of dispersion or coating composition to the substrate or else it can comprise several stages of application (for example 2, 3, 5, . . . 10) according in particular to the properties and/or thickness desired for the film or coating.

The process according to the invention can comprise, in addition to said stage or stages of application of the dispersion or coating composition to the substrate, one or more other stages.

This or these other stages can in particular be one or more stages of drying the dispersion or coating composition applied to or deposited on the substrate for the purpose of forming the film or coating on the substrate.

During this or these drying stages, the dispersion or coating composition which has formed a “wet” film or coating on the substrate is dried in order to form the final “dry” film or coating on the substrate.

The “wet” film, before drying, can, for example, have a thickness from 100 μm to 1000 μm, for example from 200 μm to 400 μm.

In the case where just one stage of application of dispersion or coating composition to the substrate is carried out, this application stage is generally followed by a final drying stage.

In the case where several stages of application to the substrate are carried out, it is possible to carry out drying after each stage of application of dispersion or coating composition or else to carry out a single final drying stage after application of all the layers.

The drying operation(s) can be carried out at a temperature and for a period of time which are sufficient to form the film or coating on the substrate.

The drying operation(s) can be carried out, for example, at ambient temperature (15 to 30° C., for example 20 to 25° C.) for a total period of time of 1 to 48 hours, for example 24 hours, or by using any appropriate heating device.

Typically, the drying operation(s) can be carried out for a total period of time of 24 hours and at a temperature of 25° C.

The drying can be carried out in the open air or in a closed chamber.

A film (after drying) generally has a thickness of 100 μm to 1000 μm, for example of 200 μm to 400 μm.

A coating generally has a thickness of 100 μm to 1000 μm, preferably of 200 μm to 400 μm. The thickness of a coating is generally greater than that of a film.

The thickness of the “dry” film or coating after drying is generally less than the thickness of the “wet” film or coating before drying.

Generally, a film is prepared by application of the dispersion whereas a coating is prepared by application of the coating composition.

The invention additionally relates to the coating or film capable of being obtained by the process for the preparation of a film or coating on a substrate described above.

The invention also relates to the use of the aqueous suspension as described above in paints; compositions or formulations for coating textiles, leather or nonwovens; adhesive compositions or formulations; or compositions for coating paper.

Surprisingly, the aqueous dispersion described above, this dispersion preferably being obtained directly by the process described below, in particular when the soft polymer(s)/hard polymer(s) ratio of this dispersion lies within the range defined above, makes it possible to prepare films or coatings having an MFT of less than or equal to 10° C., preferably of less than or equal to 5° C., more preferably of less than or equal to 0° C., and having a blocking temperature (BT) greater by at least 50° C. than the MFT.

Such films meeting these MFT and BT conditions are obtained in particular with an aqueous dispersion comprising:
from 40 to 70% of a block copolymer comprising at least one block with a T_{g} of less than or equal to 0° C. and at least one other block with a T_{g} of greater than or equal to 50° C., such as a poly(methyl methacrylate) (PMMA)/poly(butyl acrylate) (PBuA)/poly(methyl methacrylate) block copolymer with, for example, a PBuA/PMMA ratio of 60/40;
from 20 to 40% of a polymer with a glass transition temperature T_{g} of greater than or equal to 50° C., such as poly(methyl methacrylate) (PMMA);
from 0 to 20% of a polymer with a T_{g} of less than or equal to 0° C., such as poly(butyl acrylate).

The dispersion employed in the process according to the invention can exhibit the following composition:
75% of poly(methyl methacrylate)/poly(butyl acrylate)/poly(methyl methacrylate) 65% BuA/35% MMA block copolymer;
4% of PMMA;
21% of PBuA.

Alternatively, the dispersion employed can exhibit the following composition:
71% of poly(methyl methacrylate)/poly(butyl acrylate)/poly(methyl methacrylate) 72% PBuA/28% PMMA block copolymer;
20% of PMMA;
9% of PBuA.

Alternatively again, the dispersion employed can exhibit the following composition:
65% of poly(methyl methacrylate)/poly(butyl acrylate)/poly(methyl methacrylate) 53% BuA/47% MMA block copolymer;
5% of PBuA;
30% of PMMA.

As has already been specified above, the dispersion employed in the process according to the invention is generally prepared directly by a process comprising several stages of polymerization by the radical route of at least one monomer which can be polymerized by the radical route, which stages are carried out in a dispersed polymerization medium comprising an aqueous continuous liquid phase and an organic liquid phase, in which process at least one of the stages is a stage of controlled radical polymerization and at least one of the stages is a stage of conventional radical polymerization.

Such a process is described in particular in the document WO-A2-2007/017614, to the description of which reference may be made.

This process comprises the combination of at least one stage of controlled radical polymerization and of at least one stage of conventional radical polymerization.

This process makes it possible to directly prepare aqueous polymer dispersions which provide, at low temperature, namely generally a temperature of less than or equal to 10° C., preferably of less than or equal to 5° C., more preferably of less than or equal to 0° C., for the preparation of films or coatings which meet the criteria specified above as regards the difference between the blocking temperature BT and the MFT. This difference is at least 50° C., which is markedly greater than the difference between the BTs and MFTs of the films obtained from the dispersions of the prior art, which reach at most approximately 40° C. The dispersions employed in the prior art are prepared, for example, by simple blending and not directly by the specific process.

In other words, this process makes it possible to directly prepare aqueous polymer or synthetic resin dispersions which make possible the preparation at low temperature of nontacky films or coatings, the toughness and adhesion properties of which are suitable for their uses in various formulations.

Directly is understood to mean that, on conclusion of the process, the reaction medium is composed of a dispersion which can be used as is, without another stage, of drying or other, for example, to prepare a coating or film on a substrate or to be incorporated in a coating composition.

Generally, the aqueous liquid phase comprises at least 50% by weight of water.

The monomer(s) and polymer(s) generally represent at least 50% by weight of the organic phase.

Generally, the dispersed polymerization medium is provided in the form of an emulsion. The aqueous phase is the continuous phase of this emulsion, so that it is the organic phase which is found dispersed in the form of droplets with a diameter generally of 1 to 1000 nanometers.

It is possible to add at least one emulsifying agent to the polymerization medium, that is to say a surfactant which makes it possible to stabilize the emulsion, it being understood that said emulsifying agent is not an alkoxyamine. Any emulsifying agent normal to this type of emulsion can be used.

The emulsifying agent can be anionic, cationic or nonionic. The emulsifying agent can be an amphoteric or quaternary or fluorinated surfactant. It can be chosen from alkyl or aryl sulfates, alkyl- or arylsulfonates, fatty acid salts, polyvinyl alcohols or polyethoxylated fatty alcohols. By way of example, the emulsifying agent can be chosen from the following list:
sodium lauryl sulfate,
sodium dodecylbenzenesulfonate,
sodium stearate,
polyethoxylated nonylphenol,
sodium dihexyl sulfosuccinate,
sodium dioctyl sulfosuccinate,
lauryldimethylammonium bromide,
lauryl amido betaine,
potassium perfluorooctylacetate,
alkyldiphenyl oxide sulfonate, such as the Dowfax Dowfax® compounds from Dow, in particular Dowfax® 8390.

The emulsifying agent can also be an amphiphilic block or random or grafted copolymer, such as sodium styrenesulfonate copolymers and in particular polystyrene-b-poly(sodium styrenesulfonate).

The emulsifying agent can be introduced into the polymerization medium in a proportion of 0.1 to 10% by weight, with respect to the weight of monomer(s). Instead of being added, the emulsifying agent can be synthesized in situ in the polymerization medium, more specifically in the case of an amphiphilic copolymer. It then also represents from 0.1 to 10% by weight, with respect to the weight of monomers.

The emulsion can be a miniemulsion or a microemulsion, that is to say an emulsion in which the organic phase forms droplets with a diameter generally of less than 2 micrometers and generally ranging from 100 to 1000 nanometers.

The miniemulsion state is obtained by virtue of sufficient shearing of the liquid and by virtue of the presence in the miniemulsion of a hydrophobic polymer and of a cosolvent.

The hydrophobic polymer must be soluble in the organic phase; it preferably exhibits a solubility in water at 25° C. of less than 1×10⁻⁶ g/liter and exhibits a weight-average molecular weight at least equal to 100 000, for example ranging from 100 000 to 400 000. By way of example, the hydrophobic polymer can be polystyrene, polymethyl methacrylate or polybutyl acrylate.

The hydrophobic polymer can be introduced into the emulsion in a proportion of 0.5 to 2% by weight, with respect to the monomer to be polymerized.

The cosolvent exhibits a hydrocarbon sequence of at least six carbon atoms, exhibits a solubility in water at 25° C. of less than 1×10⁻⁶ g/liter and is liquid at the polymerization temperature.

If the cosolvent does not comprise fluorine atoms, the hydrocarbon sequence preferably comprises at least 12 carbon atoms.

By way of example, the cosolvent can be:
hexadecane,
stearyl methacrylate,
dodecyl methacrylate,
perfluorooctyl methacrylate.

The sufficient shearing in order to obtain the miniemulsion state can be produced by vigorous stirring, for example obtained by ultrasound. Once the miniemulsion state has been obtained, it is generally possible to reduce the shearing, the latter being brought back to that which is usual for emulsions in general, while retaining the miniemulsion state.

Monomers are understood to mean any monomer which can be polymerized or copolymerized by the radical route. The term “monomer” covers, of course, mixtures of several monomers.

The monomer can be chosen from monomers exhibiting a carbon-carbon double bond capable of polymerizing by the radical route, such as vinyl, vinylidene, diene, olefinic and allyl monomers, and the like.

Vinyl monomers is understood to mean, inter alia, (meth)acrylic acid, (meth)acrylates, in particular alkyl(meth)acrylates, vinylaromatic monomers, vinyl esters, (meth)acrylonitriles, (meth)acrylamides and mono- and di(alkyl)(meth)acrylamides, maleic acid, maleic anhydride and the monoesters and diesters of maleic anhydride and of maleic acid.

In the present document and unless otherwise mentioned, the alkyl and alkoxy groups can be linear or branched and generally have from 1 to 18 carbon atoms.

The cycloalkyl groups generally have from 3 to 18 carbon atoms, the alkenyl groups generally have from 2 to 18 carbon atoms, the aryl groups generally have from 6 to 20 carbon atoms and the alkylene groups generally have from 1 to 18 carbon atoms.

The monomers under consideration can in particular be chosen from vinylaromatic monomers, such as styrene or substituted styrenes, in particular α-methyl-styrene and sodium styrenesulfonate, dienes, such as butadiene or isoprene, acrylic monomers, such as acrylic acid or its salts, alkyl, cycloalkyl or aryl acrylates, such as methyl, ethyl, butyl, ethylhexyl or phenyl acrylate, hydroxyalkyl acrylates, such as 2-hydroxyethyl acrylate, ether alkyl acrylates, such as 2-methoxyethyl acrylate, alkoxy- or aryloxypolyalkylene glycol acrylates, such as methoxypolyethylene glycol acrylates, ethoxypolyethylene glycol acrylates, methoxypolypropylene glycol acrylates, methoxy-polyethylene glycol-polypropylene glycol acrylates or their mixtures, aminoalkyl acrylates, such as 2-(dimethylamino)ethyl acrylate (ADAME), acrylates of amine salts, such as [2-(acryloyloxy)ethyl]trimethylammonium chloride or sulfate or [2-(acryloyloxy)ethyl]dimethylbenzylammonium chloride or sulfate, fluoroacrylates, silylated acrylates or phosphorus-comprising acrylates, such as alkylene glycol acrylate phosphates, methacrylic monomers, such as methacrylic acid or its salts, alkyl, cycloalkyl, alkenyl or aryl methacrylates, such as methyl, lauryl, cyclohexyl, allyl or phenyl methacrylate, hydroxyalkyl methacrylates, such as 2-hydroxyethyl methacrylate or 2-hydroxypropyl methacrylate, ether alkyl methacrylates, such as 2-hydroxypropyl methacrylate, alkoxy- or aryloxypolyalkylene glycol methacrylates, such as methoxypolyethylene glycol methacrylates, ethoxypolyethylene glycol methacrylates, methoxypolypropylene glycol methacrylates, methoxypolyethylene glycol-polypropylene glycol methacrylates or their mixtures, aminoalkyl methacrylates, such as 2-(dimethylamino)-ethyl methacrylate (MADAME), methacrylates of amine salts, such as [2-(methacryloyloxy)ethyl]trimethylammonium chloride or sulfate or [2-(methacryloyloxy)ethyl]dimethylbenzylammonium chloride or sulfate, fluoromethacrylates, such as 2,2,2-trifluoroethyl methacrylate, silylated methacrylates, such as 3-methacryloyloxypropyltrimethylsilane, phosphorus-comprising methacrylates, such as alkylene glycol methacrylate phosphates, hydroxyethylimidazolidone methacrylate, hydroxyethylimidazolidinone methacrylate or 2-(2-oxo-1-imidazolidinyl)ethyl methacrylate, acrylonitrile, acrylamide or substituted acrylamides, 4-acryloylmorpholine, N-methylolacrylamide, acrylamidopropyltrimethylammonium chloride (APTAC), acrylamidomethylpropanesulfonic acid (AMPS) or its salts, methacrylamide or substituted methacrylamides, N-methylolmethacrylamide, methacrylamidopropyltrimethylammonium chloride (MAPTAC), itaconic acid, maleic acid or its salts, maleic anhydride, alkyl or alkoxy- or aryloxypolyalkylene glycol maleates or hemimaleates, vinylpyridine, vinylpyrrolidinone, (alkoxy)poly(alkylene glycol) vinyl ethers or divinyl ethers, such as methoxypoly(ethylene glycol) vinyl ether or poly(ethylene glycol) divinyl ether, olefinic monomers, among which may be mentioned ethylene, butene, hexene and 1-octene, as well as fluoroolefinic monomers and vinylidene monomers, among which may be mentioned vinylidene fluoride, alone or as a mixture of at least two abovementioned monomers.

The monomers listed above can be employed just as easily during the stage or stages of controlled radical polymerization as during the stage or stages of conventional radical polymerization of the process resulting directly in the dispersions used according to the invention.

According to an essential characteristic of the process for the preparation of the dispersion employed in the process according to the invention, at least one of the stages of radical polymerization of this process for the preparation of the dispersion is thus a stage of controlled radical polymerization.

The controlled radical polymerization technique comprises several alternative forms according to the nature of the control agent which is used.

Preferably, in the preferred process of the preparation of the dispersion employed in the process according to the invention, the stage(s) of controlled radical polymerization is(are) a(one of the) “SFRP” stage(s) carried out in the presence of stable free radicals which preferably use(s) nitroxides T as control agents and an alkoxyamine (this alkoxyamine is generally soluble in water but it may be soluble in organic solvents in the case of a miniemulsion), for example a difunctional alkoxyamine, as initiator.

Use may be made, as alkoxyamine, of a monofunctional alkoxyamine corresponding to the following formula (I):

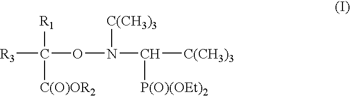

in which:
R₁ and R₃, which are identical or different, represent a linear or branched alkyl group having a number of carbon atoms ranging from 1 to 3;
R₂ represents a hydrogen atom, an alkali metal, such as Li, Na or K, an ammonium ion, such as NH₄⁺, NBu₄⁺ or NHBu₃⁺, a linear or branched alkyl group having a number of carbon atoms ranging from 1 to 8, or a phenyl group.

A preferred monofunctional alkoxyamine is 2-methyl-2-[N-(tert-butyl)-N-(1-diethoxyphosphoryl-2,2-dimethylpropyl)aminoxy]propionic acid, which corresponds to the following formula (II):

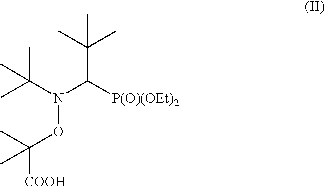

Alternatively, use may be made, as alkoxyamine, of a polyfunctional alkoxyamine corresponding to the following formula (III):

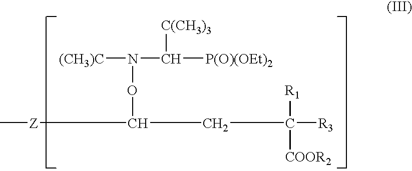

in which:
R₁, R₂ and R₃ are as defined above,
Z represents an aryl group or a group of formula Z₁—[X—C(O)]ₙ, in which Z₁ represents a polyfunctional structure originating, for example, from a compound of the polyol type, X is an oxygen atom, a nitrogen atom carrying a carbon group, such as an alkyl group of 1 to 10 carbon atoms, or a hydrogen atom, or a sulfur atom, and n is an integer greater than or equal to 2.

The polyfunctional alkoxyamine can in particular be a difunctional alkoxyamine or dialkoxyamine, for example of formula:

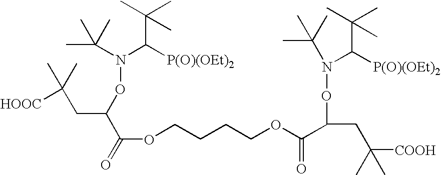

The alkoxyamine is generally soluble in water but can in some cases be soluble in organic solvents.

The stage or stages of controlled radical polymerization are generally carried out at a temperature of 20 to 180° C. and preferably of 40 to 130° C. This or these stage(s) are generally carried out at a pressure sufficient to prevent boiling of the phases of the emulsion and for its various constituents to remain essentially in the emulsion.

The stage or stages of controlled radical polymerization are generally carried out in an atmosphere of inert gas, for example of nitrogen.

Before entering in more detail into a description of the stages of the preferred process which makes it possible to directly prepare the dispersions employed according to the invention, it is specified first of all that, in the context of the present invention, the term polymer is to be taken in its most general sense so that it covers homopolymers, copolymers, terpolymers and blends of polymers. In addition, it is specified that block copolymers is understood to mean linear or radial molecules composed of an alternation of long homogeneous blocks; they can be diblock, triblock or multiblock.

It is specified that precursor monomer of a block, for example of a block A, and precursor monomer of a block A′ are understood to mean the monomers which, after polymerization, will respectively constitute the repeat units of the block A and of the block A′.

Different blocks is understood to mean generally that these blocks are of the same nature with regard to the monomers of which they are composed but can be of different lengths.

It is specified that Et is understood to mean an ethyl group and Bu is understood to mean a butyl group which can exist in its different isomers.

T_{g} denotes the glass transition temperature of a polymer, measured by DSC according to ASTM E1356. Reference is also made to the T_{g} of a monomer to denote the T_{g} of the homopolymer having a number-average molecular weight Mₙ of at least 10 000 g/mol obtained by radical polymerization of said monomer. Thus, it will be stated that styrene has a T_{g} of 100° C. as homopolystyrene has a T_{g} of 100° C.

All the percentages are given by weight, unless otherwise mentioned.

A block polymer is prepared during the stages of controlled radical polymerization, it being possible for this polymer to be in particular a diblock polymer A-B or a triblock polymer A-B-A′ and preferably A-B-A, if A and A′ are identical.

Thus, in a first stage of controlled radical polymerization of the process of the preparation of the dispersion employed according to the invention, the polymerization is carried out by controlled radical polymerization of a first precursor monomer or of a first mixture of precursor monomers in order to form or give a living polymer block B and a residual monomer or a mixture of residual monomers.

In a second stage of controlled radical polymerization of the preferred process for the preparation of the dispersion, the living polymer block B can be brought into contact with a second monomer or a second mixture of monomers, the polymerization of which forms or gives a polymer block A connected to the polymer block B, or two polymer blocks A and A′, which are identical or different, each connected to the polymer block B, and a residual monomer or a mixture of residual monomers.

At any moment, stages of conventional radical polymerization, consisting of converting a monomer or a mixture of monomers to polymers, can be carried out, in particular in order to remove the residual monomers or mixtures of residual monomers (as is described in the document FR-A-2 889 703 of Arkema).

In practice, the blocks can be prepared in succession to one another in the same equipment. When the first monomer is consumed so as to produce the first block, it is sufficient to introduce the second monomer intended for the preparation of the second block, without halting the stirring and without cooling or other interruption. Of course, the conditions for forming each of the blocks, such as the temperature of emulsion, can be adjusted according to the nature of the monomers.

Of course, it is possible to add as many blocks as desired to the living polymer by placing the latter in a medium for the polymerization of a monomer from which it is desired to form a block.

Thus, on conclusion of the stages of controlled radical polymerization, it is possible to obtain block copolymers A-B-A′, preferably A-B-A, or A-B, it being possible for A, A′ and B to be without distinction, independently of one another, hard or soft. It should be specified that “soft” polymer is understood to mean that this polymer, whether isolated, separate and independent or whether it constitutes a block of a block copolymer, has a glass transition temperature T_{g} generally of less than or equal to 10° C.

Likewise, “hard” polymer is understood to mean that this polymer, whether isolated, separate and independent or whether it constitutes a block of a block copolymer, has a glass transition temperature T_{g} generally of greater than or equal to 50° C.

The block A can be a homopolymer or a copolymer, for example a random copolymer.

The block A′ can be a homopolymer or a copolymer, for example a random copolymer.

The block B can be a homopolymer or a copolymer, for example a random copolymer.

The precursor monomer or monomers of the block B are preferably chosen from alkyl (for example of 1 to 18 carbon atoms) acrylates.

The precursor monomer or monomers of the block A and of the block A′ are preferably chosen from alkyl (for example of 1 to 18 carbon atoms) methacrylates and styrene compounds and their derivatives, some of which have been mentioned above.

The block A and the block A′ are preferably chosen from hard rigid blocks with a glass transition temperature T_{g} of greater than or equal to 50° C.

The block B is preferably chosen from soft blocks with a glass transition temperature of less than or equal to 10° C.

By way of examples, the following block copolymers can be obtained on conclusion of the stages of controlled radical polymerization of the preferred process for the preparation of the dispersion employed according to the invention:
poly(methyl methacrylate)-b-poly(butyl acrylate)-b-poly(methyl methacrylate).

The preferred process employed to prepare the dispersion employed according to the invention comprises, apart from at least one stage of controlled radical polymerization as described above, at least one stage of conventional radical polymerization.

Stage of conventional radical polymerization is understood to mean that this stage is a stage of conventional radical polymerization and is not a stage of controlled radical polymerization, as was defined above.

Conventional free radical polymerization processes are known to a person skilled in the art and thus do not require a more detailed description.

An example of a conventional preparation process is a process in a dispersed medium in the presence of a conventional radical polymerization initiator at a temperature of less than or equal to 80° C.

The conventional radical polymerization stages can be carried out at any moment of the process.

During the stage or each of the stages of conventional radical polymerization, generally a homopolymer or a copolymer, generally a random copolymer, is prepared.

Advantageously, the stage or stages of controlled radical polymerization and the stage or stages of conventional radical polymerization are generally carried out successively in the same reactor or the same chamber.

The stage or stages of conventional radical polymerization are generally carried out in the polymerization medium resulting from the stage of controlled radical polymerization immediately preceding each of these stages of conventional radical polymerization, said polymerization medium generally comprising one or more residual monomers.

Preferably, during one or more of the stages of conventional radical polymerization (for example during all the stages), the polymerization is carried out of the residual monomer or monomers which has/have not reacted during the stage of controlled radical polymerization immediately preceding said stage or each of the stages of conventional radical polymerization.

However, it is also possible to add one or more other monomers to this or these residual monomers and to carry out, during one or more among the stages of conventional radical polymerization, the polymerization of this or these residual monomers with said other monomer or monomers added.

It is also possible, during one or more among the stages of conventional radical polymerization, to remove said residual monomers from the medium resulting from the preceding stage of controlled radical polymerization, to add one or more other monomers to this medium and to carry out the conventional radical polymerization only of this or these added monomers.

On conclusion of this or these stages of conventional radical polymerization, polymers C and D, for example, are obtained.

C can be a homopolymer or a copolymer, preferably a random copolymer.

D can be a homopolymer or a copolymer, preferably a random copolymer.

C and D can be identical to or different from A and/or A′ and/or B as defined above.

A preferred process for preparing the dispersion employed according to the invention can thus comprise the following stages:

a) a first stage of controlled radical polymerization in which the controlled radical polymerization is carried out of a first precursor monomer or of a first mixture of precursor monomers to give a living polymer block B and a residual monomer or a mixture of residual monomers;

b) a second stage of controlled radical polymerization in which the living polymer block B is brought into contact with a second monomer or a second mixture of monomers, the polymerization of which gives a polymer block A connected to the polymer block B or two polymer blocks A and N, which are identical or different, each connected to the polymer block B, and a residual monomer or a mixture of residual monomers.

At any moment of the process, it is possible to carry out one or more stages of conventional radical polymerization in which the polymerization of a monomer or a mixture of monomers is carried out to give one or more polymers. The monomer or the mixture of monomers polymerized during the stage or stages of conventional polymerization are generally the residual monomer or the mixture of residual monomers resulting from the stages of controlled radical polymerization or else only one or more added monomers or alternatively a mixture of said residual monomer or monomers and of one or more added monomers.

In other words, at any moment, stages of conventional radical polymerization, consisting in converting a monomer or a mixture of monomers to polymers, can be carried out, in particular in order to remove the residual monomers or the mixtures of residual monomers resulting from the stages of controlled radical polymerization, as is described in the document FR-A-2 889 703.

A more preferred process for preparing the dispersion employed according to the invention can thus comprise the following stages:

a) a first stage of controlled radical polymerization in which the controlled radical polymerization is carried out of a first precursor monomer or of a first mixture of precursor monomers to give a living polymer block B and a residual monomer or a mixture of residual monomers;

b) a first stage of (conventional) free radical polymerization in which the conventional radical polymerization is carried out of the residual monomer or of the mixture of residual monomers from stage a), to form a polymer C;

c) a second stage of controlled radical polymerization in which the living polymer block B is brought into contact with a second monomer or a second mixture of monomers, the polymerization of which gives a polymer block A connected to the polymer block B or two polymer blocks A and N, which are identical or different, each connected to the polymer block B, and a residual monomer or a mixture of residual monomers;

d) optionally a second stage of conventional radical polymerization in which the conventional radical polymerization is carried out of the residual monomers from stage c), to form a polymer D.

In this case, the polymer C generally comprises the same monomer or monomers as those from which the block B derives and the polymer D comprises the same monomer or monomers as those from which the block A and the block A′ derive(s).

The stages of controlled radical polymerization are preferably carried out with an alkoxyamine, more preferably with a difunctional alkoxyamine, such as described above.

The process described above makes it possible, on its completion, to directly obtain aqueous dispersions of polymer particles, in other words aqueous dispersions of latex particles composed of a mixture, on the one hand, of one or more block copolymers and, on the other hand, of homopolymers or random copolymers.

The invention will now be described with reference to the following examples, given by way of illustration and without implied limitation:

### EXAMPLES

### Example 1A

### Preparation of 2-methyl-2-[N-(tert-butyl)-N-(1-diethoxyphosphoryl-2,2-dimethylpropyl)aminoxy]propionic acid

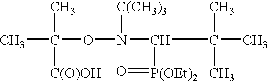

Procedure:

500 ml of degassed toluene, 35.9 g of CuBr (250 mmol), 15.9 g of copper powder (250 mmol) and 86.7 g of N,N,N′,N′,N″-pentamethyldiethylenetriamine (PMDTA) (500 mmol) are introduced into a 2 l glass reactor purged with nitrogen and then a mixture comprising 500 ml of degassed toluene, 42.1 g of 2-bromo-2-methylpropionic acid (250 mmol) and 78.9 g of 84% SG1, i.e. 225 mmol is introduced with stirring and at ambient temperature (20° C.).

Reaction is allowed to take place at ambient temperature and with stirring for 90 min and then the reaction medium is filtered. The toluene filtrate is washed twice with 1.5 l of a saturated aqueous NH₄Cl solution.

A yellowish solid is obtained and is washed with pentane to give 51 g of 2-methyl-2-[N-(tert-butyl)-N-(1-diethoxyphosphoryl-2,2-dimethylpropyl)-aminoxy]propionic acid (yield 60%).

The analytical results are given below:
molar mass determined by mass spectrometry: 381.44 g.mol⁻¹ (for C₁₇H₃₆NO₆P)

elemental analysis (empirical formula: C₁₇H₃₆NO₆P):

% calculated: C, 53.53; H, 9.51; N, 3.67.

found: C, 53.57; H, 9.28; N, 3.77.
melting carried out on a Büchi B-540 device: 124° C./125° C.

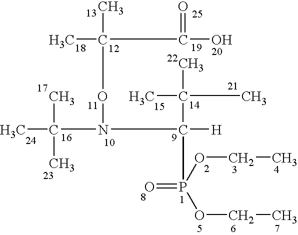

³¹P NMR(CDCl₃): δ 27.7
¹H NMR(CDCl₃):
   δ 1.15 (singlet, 9H on carbons 15, 21 and 22),
   δ 1.24 (singlet, 9H on carbons 17, 23 and 24),
   δ 1.33-1.36 (multiplet, 6H on carbons 4 and 7),
   δ 1.61 (multiplet, 3H on carbon 18),
   δ 1.78 (multiplet, 3H on carbon 13),
   δ 3.41 (doublet, 1H on carbon 9),
   δ 3.98-4.98 (multiplet, 4H on carbons 3 and 6),
   δ 11.8 (singlet, —OH).
¹³C NMR(CDCl₃):

| Carbon atom number | δ |
|---|---|
| 3 and 6 | 60.28-63.32 |
| 9 | 69.86 |
| 12 | 63 |
| 13 | 28.51 |
| 14 | 36.04 |
| 15, 21 and 22 | 29.75 |
| 16 | 63.31 |
| 17, 23 and 24 | 28.74 |
| 18 | 24.08 |
| 19 | 176.70 |

kd (120° C.)=0.2 s⁻¹.

### Example 1B

### Preparation of a dialkoxyamine starting from the monoalkoxyamine obtained in 1A

The following are introduced into a 100 ml round-bottomed flask purged with nitrogen:
2 g of the alkoxyamine prepared under 1A (2 equivalents),
0.52 g of 1,4-butanediol diacrylate with a purity of greater than 98% (1 equivalent),
6.7 ml of ethanol.

The mixture is heated at reflux (temperature 78° C.) for 20 h and then the ethanol is evaporated under vacuum. 2.5 g of a highly viscous yellow oil are obtained.

The ³¹P NMR analysis shows the complete disappearance of the 2-methyl-2-[N-(tert-butyl)-N-(1-diethoxyphosphoryl-2,2-dimethylpropyl)aminoxy]propionic acid (27.4 ppm) and the appearance of the dialkoxyamine (multiplet at 24.7-25.1 ppm).

The analysis by mass spectrometry of electrospray type shows the mass 961 (M⁺).

### Example 2

### Preparation as an emulsion of a latex of poly(methyl methacrylate)/poly(butyl acrylate)/poly(methyl methacrylate) block copolymer, the butyl acrylate/methacrylate ratio by weight of which is 70/30

The synthesis is carried out in five stages:

1^{st} stage: Preparation of a poly(butyl acrylate) seed comprising a low level of solids (approximately 1% by weight)

7.3 g of butyl acrylate, 526.1 g of water, 22.6 g of a 35% by weight aqueous solution of emulsifying agent Dowfax 8390, 0.58 g of NaHCO₃ and 1.2 g of alkoxyamine II (but it might also be, for example, the dialkoxyamine obtained in example 1B), neutralized beforehand with an excess of sodium hydroxide (1.6 equivalents per mole of COOH functional group), are introduced into a 1 1 reactor equipped with a jacket. The solution is degassed with nitrogen for 10 minutes. The reaction medium is then brought to 120° C. and this temperature is maintained by thermal regulation for 2 hours.

2^{nd} stage: Augmentation of the seed by continuous addition of butyl acrylate

168 g of butyl acrylate, degassed beforehand, are continuously added to the preceding seed over a period of 3 hours at 120° C. The temperature is maintained by thermal regulation until the targeted conversion has been achieved. Samples are taken throughout the reaction in order to determine the kinetics of polymerization and to estimate the conversion of the butyl acrylate after measuring the solids content. When the targeted conversion has been achieved (70%), the temperature of the reactor is lowered to 80° C.

3^{rd} stage: Curing of the residual butyl acrylate by a conventional radical polymerization process

1.14 g of n-dodecyl mercaptan, 7.96 g of an 11% by weight aqueous sodium formaldehydesulfoxylate solution and 7.89 g of an 11% by weight aqueous potassium persulfate solution are added at 80° C. and the temperature is maintained by thermal regulation for 2 hours.

4^{th} stage: Reinitiation of the living polybutyl acrylates with methyl methacrylate

The temperature of the reactor is subsequently brought to 105° C. and 75.1 g of methyl methacrylate, degassed beforehand, are continuously added at 105° C. over a period of 2 hours. The temperature is maintained by thermal regulation for an additional two hours after the end of the addition. The methyl methacrylate conversion reaches 86%. The temperature of the reactor is then lowered to 80° C.

5^{th} stage: Curing the residual methyl methacrylate by a conventional radical polymerization process

0.21 g of n-dodecyl mercaptan, 0.15 g of sodium formaldehydesulfoxylate and 0.15 g of potassium persulfate are added at 80° C. and the temperature is maintained by thermal regulation for 2 hours. Subsequently, the temperature of the reaction medium is then lowered to ambient temperature.
The final latex, which exhibits the following composition:
75% of poly(methyl methacrylate)/poly(butyl acrylate)/poly(methyl methacrylate) 65% BuA/35% MMA block copolymer,
4% of PMMA,
21% of PBuA,
is recovered after emptying the reactor.

### Example 3

### Preparation as an emulsion of a latex of poly(methyl methacrylate)/poly(butyl acrylate)/poly(methyl methacrylate) block copolymer, the butyl acrylate/methacrylate ratio by weight of which is 60/40

The synthesis is carried out in five stages:

1^{St} stage: Preparation of a poly(butyl acrylate) seed comprising a low level of solids (approximately 1% by weight)

117.2 g of butyl acrylate, 10300 g of water, 501.9 g of a 35% by weight aqueous solution of emulsifying agent Dowfax 8390, 1000 g of a 1.3% by weight aqueous NaHCO₃ solution and 76 g of alkoxyamine II (but it might also be, for example, the dialkoxyamine obtained in example 1B), neutralized beforehand with an excess of sodium hydroxide (1.6 equivalents per mole of COOH functional group), are introduced into a 20 L reactor equipped with a jacket. The solution is degassed with nitrogen for 10 minutes. The reaction medium is then brought to 120° C. and this temperature is maintained by thermal regulation for two hours.

2^{nd} stage: Augmentation of the seed by continuous addition of butyl acrylate

3396 g of butyl acrylate, degassed beforehand, are continuously added to the preceding seed at 120° C. over a period of three hours. The temperature is maintained by thermal regulation until the targeted conversion has been achieved. Samples are taken throughout the reaction in order to determine the kinetics of polymerization and estimate the conversion of the butyl acrylates after measuring the solids content. When the targeted conversion has been achieved (85%), the temperature of the reactor is lowered to 80° C.

3^{rd} stage: Curing the residual butyl acrylate by a conventional radical polymerization process

4.48 g of n-dodecyl mercaptan, 33.6 g of a 10% by weight aqueous sodium formaldehydesulfoxylate solution and 67.2 g of a 5% by weight aqueous potassium persulfate solution are added at 80° C. and the temperature is maintained by thermal regulation for two hours.

4^{th} stage: Reinitiation of the living polybutyl acrylate with methyl methacrylate

The temperature of the reactor is subsequently brought to 105° C. and 2342.1 g of methyl methacrylate, degassed beforehand, are continuously added at 105° C. over a period of two hours. The temperature is maintained by thermal regulation for an additional two hours after the end of the addition. The conversion of the methyl methacrylate reaches 50%. The temperature of the reactor is then lowered to 80° C.

5^{th} stage: Curing the residual methyl methacrylate by a conventional radical polymerization process

23.4 g of n-dodecyl mercaptan, 17.6 g of sodium formaldehydesulfoxylate and 17.6 g of potassium persulfate are added at 80° C. and the temperature is maintained by thermal regulation for two hours. Subsequently, the temperature of the reaction medium is then lowered to ambient temperature.

The final latex, which exhibits the following composition:
71% of poly(methyl methacrylate)/poly(butyl acrylate)/poly(methyl methacrylate) 72% PBuA/28% PMMA block copolymer,
20% of PMMA,
9% of PBuA,

is recovered after emptying the reactor.

### Example 4

### Preparation as an emulsion of a latex of poly(methyl methacrylate)/poly(butyl acrylate)/poly(methyl methacrylate) block copolymer, the butyl acrylate/methacrylate ratio by weight of which is 40/60

The synthesis is carried out in five stages:

1^{st} stage: Preparation of a poly(butyl acrylate) seed comprising a low level of solids (approximately 1% by weight)

3.9 g of butyl acrylate, 254.7 g of water, 18.4 g of a 35% by weight aqueous solution of emulsifying agent Dowfax 8390, 0.28 g of NaHCO₃ and 2.11 g of alkoxyamine II (but it might also be, for example, the dialkoxyamine obtained in example 1B), neutralized beforehand with an excess of sodium hydroxide (1.6 equivalents per mole of COOH functional group), are introduced into 1 L reactor equipped with a jacket. The solution is degassed with nitrogen for 10 minutes. The reaction medium is then brought to 120° C. and this temperature is maintained by thermal regulation for two hours.

2^{nd} stage: Augmentation of the seed by continuous addition of butyl acrylate

97.6 g of butyl acrylate, degassed beforehand, are continuously added to the preceding seed at 120° C. over a period of three hours. The temperature is maintained by thermal regulation until the targeted conversion has been achieved. Samples are taken throughout the reaction in order to determine the kinetics of polymerization and to estimate the conversion of the butyl acrylate after measuring the solids content. When the targeted conversion has been achieved (88%), the temperature of the reactor is lowered to 80° C.

3^{rd} stage: Curing the residual butyl acrylate by a conventional radical polymerization process

0.22 g of n-dodecyl mercaptan, 0.16 g of sodium formaldehydesulfoxylate and 0.16 g of potassium persulfate are added at 80° C. and the temperature is maintained by thermal regulation for two hours.

4^{th} stage: Reinitiation of the living polybutyl acrylate with methyl methacrylate

The temperature of the reactor is subsequently brought to 105° C. and 250 g of water and 146 g of methyl methacrylate, degassed beforehand, are continuously added at 105° C. over a period of two hours. The temperature is maintained by thermal regulation for an additional two hours after the end of the addition. The conversion of the methyl methacrylate reaches 51%. The temperature of the reactor is then lowered to 80° C.

5^{th} stage: Curing the residual methyl methacrylate by a conventional radical polymerization process

0.39 g of n-dodecyl mercaptan, 0.29 g of sodium formaldehydesulfoxylate and 0.29 g of 5% by weight potassium persulfate are added at 80° C. and the temperature is maintained by thermal regulation for two hours. Subsequently, the temperature of the reaction medium is then lowered to ambient temperature.

The final latex, which exhibits the following composition:
65% of poly(methyl methacrylate)/poly(butyl acrylate)/poly(methyl methacrylate) 53% BuA/47% MMA block copolymer,
5% of PBuA,
30% of PMMA,
   is recovered after emptying the reactor.

### Example 5

### Evaluation of the latexes of block copolymers obtained above in comparison with “core/shell” materials of the prior art (U.S. Pat. No. 5,306,743)

Determination of the MFT:

The MFT was determined with regard to the pure aqueous polymer emulsion. The wet film produced has a thickness of 400 μm. The latex film was dried at different temperatures. The MFT is the temperature at which cracks begin to appear on the film.

Determination of the Blocking Temperature:

The pure aqueous polymer emulsion is applied to a weakly adsorbent paper (Lenetta card). The wet film produced has a thickness of 200 μm. The latex film is dried at 25° C. for 24 h. Two strips of 20×100 mm of the paper covered with the polymer film are cut out from the Lenetta card and superimposed on one another, perpendicularly to one another, so as to obtain a contact surface area of 2 cm², with the faces covered with the polymer film in contact. The two strips are kept in contact under a weight of 2 kg for 4 h at different temperatures. The blocking temperature (BT) is the temperature from which the surface of the films is damaged when the two strips are separated from one another.

The results of the measurements of the MFT and of the BT are combined in the following table I:

TABLE I

| Latex | MFT | BT |
|---|---|---|
| Example 2 | <0° C. | >50° C. |
| (Soft polymers/hard | | |
| polymers ratio = 2.3) | | |
| Example 3 | <0° C. | >50° C. |
| (Soft polymers/hard | | |
| polymers ratio = 1.5) | | |
| Example 4 | <0° C. | >50° C. |
| (Soft polymers/hard | | |
| polymers ratio = | | |
| 0.66) | | |
| Comparative | 0° C. | 40° C. |
| example: | | |
| Core/shell latex | | |
| U.S. Pat. No. 5,306,743 | | |
| (Examples 2, 3, 4) | | |
| Comparative | 12° C. | 55° C. |
| example: Core/shell | | |
| latex | | |
| U.S. Pat. No. 5,306,743 | | |
| (Example 6) | | |

It is apparent on reading the table that the films prepared by employing the process according to the invention, which uses latexes of polymers prepared directly by the process described above, all have low MFT temperatures, namely of less than 0° C., and high BT temperatures, namely of greater than 50° C. The temperature difference between MFT and BT is thus, in all cases, greater than 50° C. for the films prepared by the process according to the invention from these latexes.

The films prepared by a process not in accordance with the invention using latexes of polymers such as represented by the document U.S. Pat. No. 5,603,743 do not simultaneously exhibit an MFT of less than 0° C. and a BT of greater than 50° C. and the temperature difference between MFT and BT, which reaches at the most 43° C., is never greater than 50° C.

1. A process for the preparation of a film or coating on a solid substrate, comprising the step of applying to the substrate an aqueous coating composition comprising of an aqueous dispersion of polymer particles composed of a blend of one or more block copolymers and of one or more homopolymers and/or random copolymers.

2. The process as claimed in claim 1, in which the film or coating has a Minimal Filmification Temperature (MFT) of less than or equal to 10° C. and a blocking temperature (BT) greater by at least 50° C. than the MFT.

3. The process as claimed in claim 1, in which the block copolymer or copolymers represent from 40 to 80%, of the total of the polymers of the dispersion and the homopolymer or homopolymers and/or random copolymer or copolymers represent from 0.1 to 60% of the total of the polymers of the dispersion.

4. The process as claimed in claim 1, in which the dispersion exhibits a soft polymer(s) having a glass transition temperature T_{g} of less than or equal to 10° C./hard polymer(s) having a glass transition temperature T_{g} of greater than or equal to 50° C. ratio by weight within a range from 0.3 to 3; it being possible for said polymers to be in the form of an isolated, separate and independent random copolymer or of an isolated, separate and independent homopolymer or to constitute a block of a block copolymer.

5. The process as claimed in claim 1, in which the blend comprises a triblock copolymer A-B-A′ or diblock copolymer A-B, a homopolymer or random copolymer C and optionally a homopolymer or random copolymer D.

6. The process as claimed in claim 5, in which the blocks A, B and A′ are homopolymers or copolymers.

7. The process as claimed in claim 5, in which C is composed of the same monomer or monomers as B, and D is composed of the same monomer or monomers as A or A′.

8. The process as claimed in claim 5, in which the block copolymer A-B-A′ or A-B represents between 10 and 90% of the total of the polymers of the dispersion, C represents between 0.1 and 40% of the total of the polymers of the dispersion and D, if it is present, represents between 0.1 and 40% of the total of the polymers of the dispersion.

9. The process as claimed in claim 1, in which the dispersion comprises:
from 40 to 70% of a block copolymer comprising at least one block with a T_{g} of less than or equal to 0° C. and at least one other block with a T_{g} of greater than or equal to 50° C.;
from 20 to 40% of a polymer with a T_{g} of greater than or equal to 50° C.;
from 0 to 20% of a polymer with a T_{g} of less than or equal to 0° C.

10. The process as claimed in claim 9, in which the block copolymer is a poly(methyl methacrylate) (PMMA)/poly(butyl acrylate) (PBuA)/poly(methyl methacrylate) (PMMA) block copolymer; the polymer with a T_{g} of greater than 50° C. is poly(methyl methacrylate) (PMMA); and the polymer with a T_{g} of less than or equal to 0° C. is poly(butyl acrylate) (PBuA).

11. The process as claimed in claim 10, in which the dispersion exhibits the following composition:
75% of poly(methyl methacrylate)/poly(butyl acrylate)/poly(methyl methacrylate) 65% BuA/35% MMA block copolymer;
4% of PMMA;
21% of PBuA.

12. The process as claimed in claim 10, in which the dispersion exhibits the following composition:
71% of poly(methyl methacrylate)/poly(butyl acrylate)/poly(methyl methacrylate) 72% PBuA/28% PMMA block copolymer;
20% of PMMA;
9% of PBuA.

13. The process as claimed in claim 10, in which the dispersion exhibits the following composition:
65% of poly(methyl methacrylate)/poly(butyl acrylate)/poly(methyl methacrylate) 53% BuA/47% MMA block copolymer;
5% of PBuA;
30% of PMMA,

14. The process as claimed in claim 1, in which the aqueous dispersion of polymer particles is obtained directly by a process comprising several stages of polymerization by the radical route of at least one monomer which can be polymerized by the radical route, which stages are carried out in a dispersed polymerization medium comprising an aqueous continuous liquid phase and an organic liquid phase, in which process at least one of the stages is a stage of controlled radical polymerization and at least one of the stages is a stage of conventional radical polymerization.

15. The process as claimed in claim 14, in which said monomer(s) which can be polymerized by the radical route are chosen from monomers exhibiting a carbon-carbon double bond capable of polymerizing by the radical route.

16. The process as claimed in claim 15, in which said monomers are chosen from vinyl, vinylidene, diene, olefinic and allyl monomers.

17. The process as claimed in claim 16, in which the vinyl monomers are chosen from (meth)acrylic acid, alkyl(meth)acrylates, vinylaromatic monomers, vinyl esters, (meth)acrylonitriles, (meth)acrylamides and mono- and di(alkyl)(meth)acrylamides, maleic acid, maleic anhydride and the monoesters and diesters of maleic anhydride and of maleic acid.

18. The process as claimed in claim 14, in which the block copolymer or copolymers is/are prepared during the stage or stages of controlled radical polymerization and a homopolymer or a random copolymer, such as C or D, is prepared during the stage or each of the stages of conventional radical polymerization.

19. The process as claimed in claim 1, in which the coating composition is a paint; a composition for coating textiles, leather or nonwovens; a composition for coating paper; or an adhesive composition.

20. A film or coating obtained by the process as claimed in claim 1, having an MFT of less than or equal to 10° C. and having a blocking temperature BT greater by at least 50° C. than the MFT.

21. (canceled)
